(19) United States
(12) Patent Application Publication
(10) Pub. No.: US 2025/0382178 A1
(43) Pub. Date: Dec. 18, 2025

(54) CARBON CATALYST SEPARATION

(71) Applicant: Qatar Foundation for Education, Science and Community Development, Doha (QA)

(72) Inventors: Nimir O. Elbashir, Doha (QA); Hanif Ahmed Choudhury, Doha (QA); MohamedSufiyan Challiwala, Doha (QA)

(21) Appl. No.: 18/867,500

(22) PCT Filed: May 19, 2023
(86) PCT No.: PCT/QA2023/050008

§ 371 Date: Nov. 20, 2024

Related U.S. Application Data
(60) Provisional application No. 63/365,061, filed on May 20, 2022.

(51) Int. Cl. C01B 32/05; B01J 23/90; B01J 37/03; B01J 37/04

(52) U.S. Cl. CPC C01B 32/05; B01J 23/90; B01J 37/031; B01J 37/04

(57) ABSTRACT

A method for separating a carbon material from catalyst in a carbon generation process, such as a CARGEN process, is provided. The method includes preparing a solution, mixing the solution with both carbon and the catalyst to form a supernatant mixture and a precipitate, and filtering the supernatant mixture from the precipitate.

### CROSS-REFERENCE TO RELATED APPLICATION

The present disclosure claims priority to U.S. Provisional Patent Application 63/365,061 having a filing date of May 20, 2022, the entirety of which is incorporated herein.

### BACKGROUND

Catalysts are utilized in association with industrial processes, such as, natural gas reforming for conversion of organic compounds to synthesis gas (syngas) which is an important feedstock for the production of value-added chemicals. Carbon generation/production can occur during such industrial processes and can form on the catalyst and cause catalyst deactivation. A carbon catalyst separation process is thus desired to improve on, for example, catalyst utilization and carbon generation/production and recovery thereof.

### SUMMARY

The present disclosure generally relates to a carbon catalyst separation process and system. The process and system of the present disclosure are intended to improve upon previously existing processes, systems and apparatuses for separating a carbon catalyst material. As disclosed herein, for example, the present technology provides a process and a system to solve common difficulties in carbon and syngas production. A higher recovery of carbon can be achieved through the carbon catalyst separation process according to an embodiment. Additionally, for example, the carbon catalyst separation process allows for reutilization of the catalyst which can minimize costs in acquiring what are, at times, costly catalyst materials.

In light of the present disclosure, and without limiting the scope of the disclosure in any way, in an aspect of the present disclosure, which may be combined with any other aspect described herein unless specified otherwise, a method of separating a carbon material from a catalyst in a carbon generation process includes preparing a solution, mixing the solution with the carbon material and the catalyst in a solid-liquid mixer to create a supernatant mixture and a precipitate, and filtering the supernatant mixture from the precipitate.

In another aspect of the present disclosure, which may be combined with any other aspect described herein unless specified otherwise, the carbon generation process includes a CARGEN process.

In another aspect of the present disclosure, which may be combined with any other aspect described herein unless specified otherwise, the catalyst is a material selected from the group consisting of calcite dolomite, coal, and combinations thereof.

In another aspect of the present disclosure, which may be combined with any other aspect described herein unless specified otherwise, the solution includes a hydrochloric acid and a nitric acid.

In another aspect of the present disclosure, which may be combined with any other aspect described herein unless specified otherwise, the solution includes a sulfuric acid and a nitric acid.

In another aspect of the present disclosure, which may be combined with any other aspect described herein unless specified otherwise, the solution includes a hydrochloric acid, a nitric acid, and a methanol.

In another aspect of the present disclosure, which may be combined with any other aspect described herein unless specified otherwise, the methanol has a maximum volume concentration of 50%.

In another aspect of the present disclosure, which may be combined with any other aspect described herein unless specified otherwise, the solution includes a sulfuric acid and a methanol.

In another aspect of the present disclosure, which may be combined with any other aspect described herein unless specified otherwise, the methanol has a maximum volume concentration of 50%.

In another aspect of the present disclosure, which may be combined with any other aspect described herein unless specified otherwise, the solution includes a sodium hydroxide.

In another aspect of the present disclosure, which may be combined with any other aspect described herein unless specified otherwise, the solution includes a sodium hydroxide and a methanol.

In another aspect of the present disclosure, which may be combined with any other aspect described herein unless specified otherwise, the methanol has a maximum volume concentration of 50%.

In another aspect of the present disclosure, which may be combined with any other aspect described herein unless specified otherwise, the solution has a volume concentration of 5% or less.

In another aspect of the present disclosure, which may be combined with any other aspect described herein unless specified otherwise, the solution has a molar concentration of six or less.

In another aspect of the present disclosure, which may be combined with any other aspect described herein unless specified otherwise, the solution is mixed with the carbon material and the catalyst at 50° C.

In another aspect of the present disclosure, which may be combined with any other aspect described herein unless specified otherwise, the solution is mixed with the carbon material and the catalyst for three hours.

In another aspect of the present disclosure, which may be combined with any other aspect described herein unless specified otherwise, the solution is mixed with the carbon material and the catalyst for ten minutes.

In another aspect of the present disclosure, which may be combined with any other aspect described herein unless specified otherwise, the solution is mixed with the carbon material and the catalyst for one hour.

In another aspect of the present disclosure, which may be combined with any other aspect described herein unless specified otherwise, the method of separating a carbon material from a catalyst for a carbon generation process further comprises mixing the solution with the carbon material and the catalyst by sonication to create the supernatant mixture and the precipitate.

In another aspect of the present disclosure, which may be combined with any other aspect described herein unless specified otherwise, the method of separating a carbon material from a catalyst for a carbon generation process further comprises mixing the supernatant mixture with the carbon material and the catalyst in the solid-liquid mixer to create the precipitate and filtering the supernatant mixture from the precipitate.

In another aspect of the present disclosure, which may be combined with any other aspect described herein unless specified otherwise, the method of separating a carbon material from a catalyst for a carbon generation process further comprises mixing the supernatant mixture with the carbon material and the catalyst by sonication to create the precipitate.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages described herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows a process flow diagram to depict operation of the carbon Generation Reactor (CARGEN), according to the present subject matter.

FIG. 2 shows a process flow diagram to depict operation of a two-reactor setup for enhanced CO₂ fixation, according to the present subject matter.

FIG. 3 shows a process flow diagram to depict operation of a solid carbon/catalyst recovery unit, according to the present subject matter.

FIG. 4 illustrates a mixture exiting a mixer including a supernatant liquid and a solid precipitate, according to the present subject matter.

FIG. 5 illustrates a method for separating solid carbon from a catalyst, according to the present subject matter.

FIG. 6 illustrates the method for separating solid carbon from a catalyst, according to FIG. 5 further including a step to recycle the supernatant mixture from the precipitate.

FIG. 7 illustrates the method for separating solid carbon from a catalyst, according to FIG. 6 further including sonication and further filtering steps.

### DETAILED DESCRIPTION

The present disclosure generally relates to a carbon catalyst separation. More specifically, according to an embodiment, the present disclosure relates to a carbon catalyst separation due to carbon generation/production on a catalyst utilized in an industrial process, such as a CARGEN process which is disclosed in, for example, US20230039945A1, WO2021125990A1, EP4076735A1, CN115279490A, U.S. Pat. No. 11,591,213B2, and AU2018249486B2, the entire contents of which are being incorporated herein by reference.

CARGEN technology, which has been previously disclosed in the patents U.S. Pat. No. 11,591,213B2 and AU2018249486B2, for example, represents a groundbreaking advancement in the field of natural gas reforming. This innovative process catalytically converts a greenhouse gas, such as, natural gas and carbon dioxide, into syngas and solid carbon.

Syngas, primarily composed of hydrogen and carbon monoxide, serves as a crucial raw material for the production of various high-value chemicals. Notably, it plays a significant role in the synthesis of hydrocarbon cuts, such as liquid transportation fuels via Fischer-Tropsch synthesis, as well as methanol and dimethyl ether.

On the other hand, the solid carbon produced through the CARGEN process exists in different forms, including carbon nanotubes, carbon black, graphene, graphene oxide, and graphite. Such solid carbon serves as a vital precursor with a wide range of applications, such as, the manufacturing of cement, rubber, reinforced polymers, and concrete. Additionally, for example, such solid carbon plays a pivotal role in the electronics industry for the production of batteries, conductors, chips, and various other electronic components.

The catalyst material used in the CARGEN process as disclosed in US20230039945A1, WO2021125990A1, EP4076735A1, and CN115279490A, for example, is specially designed to provide high activity and selectivity towards solid carbon formation, and specifically the carbon nanotubes form of carbon while lasting stability operation. The carbon nanotubes produced in the CARGEN process follow a tip-growth mechanism in which the catalyst material is at the tip of the grown carbon nanotubes. Compared to the overall quantity of the catalyst material comprising of active metal phase and support material, only a small fraction of the active metal phase is carried along with the carbon nanotubes at its tip, and the remaining portion remains in the bulk serving sites for syngas production. After the carbon nanotubes are formed, the bulk catalyst material needs to be separated for recycling and to improve the purity of the produced carbon nanotubes. Such a process is described herein for the carbon-catalyst separation process that aligns synergistically with the catalyst and the core principles of CARGEN technology.

The carbon catalyst separation process, in an embodiment, relates to generation/production and recovery of a highly pure carbon material (e.g., carbon nanotubes) while simultaneously enabling the recovery and recycling of the catalyst. By implementing this process, the production of a high-quality carbon material (e.g., carbon nanotubes) is achieved, fostering sustainability and resource efficiency within the CARGEN framework according to an embodiment.

As disclosed in U.S. Pat. No. 11,591,213B2, and AU2018249486B2, for example, a two-reactor system provides enhanced carbon dioxide utilization for chemical and fuels processes, while ensuring fixation of CO₂ (e.g., the amount of CO₂ utilized is less than that generated during the process). The first reactor converts CH—4+CO₂ to solid carbon, while the second reactor converts CH₄+CO₂ to syngas using a combined reforming reaction process. In view of the global concern of greenhouse gas emissions, the present system enhances overall CO₂ fixation, unlike conventional single reactor reformer systems. From a CO₂ life cycle assessment (“LCA”) and a process integration point of view, the present subject matter facilitates CO₂ utilization in methane reforming at fixation conditions while producing both solid carbon and syngas. The latter, syngas, is an important feedstock for production of a variety of value-added chemicals, as well as ultra-clean liquid fuels.

As disclosed in U.S. Pat. No. 11,591,213B2, and AU2018249486B2, for example, a combined reforming process in the present subject matter is aimed at reacting methane (or any other volatile organic compound) with CO₂, and optionally other oxidants such as O₂, H₂O, or both to produce syngas. As provided herein, optimal operating conditions of temperature and pressure of the two reactors can be determined using a thermodynamics equilibrium analysis. Any reaction feasible thermodynamically indicates that the reaction can be carried out, given that the hurdles associated with the process are tackled via the development of an efficient catalyst and reactor orientation.

As disclosed in U.S. Pat. No. 11,591,213B2, and AU2018249486B2, for example, the present subject matter aims to maximize CO₂ fixation by optimization of the operating conditions, which could maximize carbon formation in the first reactor, i.e., the Carbon Generator Reactor (CARGEN), in the limited presence of oxygen to drive the reaction auto-thermally. As the partial combustion or partial oxidation reaction is an exothermic reaction, the CARGEN reactor hosts two main reactions concerning the CO₂ fixation. The first reaction includes the conversion of CO₂ to carbon. The second reaction includes a partial oxidation reaction utilizing a portion of methane (or any other volatile organic compound) for partial combustion to produce energy, among other products. The energy provided through partial oxidation reaction is more efficient than any other form of heat transfer, as this energy is generated in-situ in the process.

As disclosed in U.S. Pat. No. 11,591,213B2, and AU2018249486B2, for example, the CARGEN reactor may be operated under low temperature and low/high pressure conditions, while the combined reformer (second reactor) may be operated at high temperature and low/high pressure conditions. By tapping the advantage of pressure and temperature swings between the two reactor units, improvements occur in both CO₂ fixation, as well as reduction in overall energy requirements of the dual reactor setup. The present subject matter also utilizes work and energy extraction processes (like turbine, expanders, etc.) associated with the change in pressure between the two reactors to overcome the pre-compression duty of the feed gas, at least partially. Thus, a unique synergism evident between the two reactors is beneficial for saving carbon credits, as well as improving sustainability of the overall process. In addition to the syngas generated from the second reactor (reformer reactor), the present process also produces solid carbon or carbonaceous material from the first reactor (CARGEN reactor). The carbonaceous product, which is produced as a part of the CO₂ fixation process, is industrially valuable, where the carbonaceous product includes, for example, a carbon nanotube, including a multi-walled carbon nanotube. In particular, the carbonaceous product may serve as a starting material to produce many value-added chemicals that can generate substantial revenue, such as, for the process plant. Non-limiting examples of valuable chemicals include activated carbon, carbon black, carbon fiber, graphite of different grades, earthen materials, etc. This material, for example, can also be added to structural materials like cement and concrete and in road tar or in wax preparation as a part of the overall CO₂ capture process.

As disclosed in U.S. Pat. No. 11,591,213B2, and AU2018249486B2, for example, the present subject matter includes utilizing a dry reforming process to convert carbon dioxide to syngas and carbon. The present subject matter enhances CO₂ fixation using a two-reactor setup or system. The reaction scheme is divided into two processes in separate reactors in series. The first reaction targets capturing CO₂ as solid carbon and the other to converting CO₂ to syngas. The present subject matter provides a systematic approach to CO₂ fixation.

As disclosed in U.S. Pat. No. 11,591,213B2, and AU2018249486B2, for example, the proposed scheme shows significant conversions of CO₂ to carbon at auto-thermal low-temperature conditions in the first reactor of the two-reactor setup. The subsequent removal of solid carbon from the system (first reactor) enhances CO₂ conversions to syngas in the second reactor by thermodynamically pushing the reaction forward. As such, the carbon from the system is removed, which is incredibly beneficial from the perspective of the CO₂ life cycle assessment (“LCA”).

There has been much research devoted to development of a novel class of catalyst targeted to resist the formation of carbon, and thus protect it from deactivation, on its surface to reduce downtime. However, such catalysts are very expensive and affect the overall economics of the process. The present subject matter as disclosed in US20230039945A1, WO2021125990A1, EP4076735A1, and CN115279490A, for example, is more economical because it instead utilizes a catalyst in the first reactor that targets or promotes carbon formation, such as carbon nanotube formation including multi-walled carbon nanotube formation. As a non-limiting example, the catalyst can include a metal including metal oxides (e.g., Fe, Ni, Co, the like and oxides thereof) and supported on a catalyst support material, such as an alumina, titania, silica, a zeolite, an inorganic clay, and the like and as further described in, for example, US20230039945A1, WO2021125990A1, EP4076735A1, and CN115279490A, which are incorporated herein by reference as previously indicated.

As disclosed in U.S. Pat. No. 11,591,213B2, and AU2018249486B2, for example, after the reaction in the first reactor, the solid carbon is filtered. The remaining product gases are fed to a higher-temperature second reactor (a combined reformer), focusing on producing high-quality syngas. Thermodynamic analysis of the results of the second reactor's operation shows no carbon formation. This drives the reaction forward at much lesser energy requirements (approximately 50 kJ less) and relatively lower temperatures in comparison to conventional reformer setups. A substantial increase in the syngas yield ratio is also seen, which is not only beneficial for syngas production for Fischer-Tropsch synthesis (requiring approximately a 2:1 H₂:CO ratio) but also for the hydrogen production (which requires high H₂:CO ratios).

As disclosed in U.S. Pat. No. 11,591,213B2, and AU2018249486B2, for example, in addition to the advantage of getting a higher H₂:CO ratio, a significant increase in the methane and carbon dioxide conversion is also seen at much lower operating temperatures. If a conventional reforming setup was used, such effects would be obtained only at higher temperatures (almost 250° C.). The advantage of removing carbon in the first reformer helps to bring down the operating temperature in the second reactor significantly. As such, the present subject matter is much more energy efficient than the conventional single reactor setup operated at higher temperatures to get similar levels of methane and carbon dioxide conversions at zero carbon deposition.

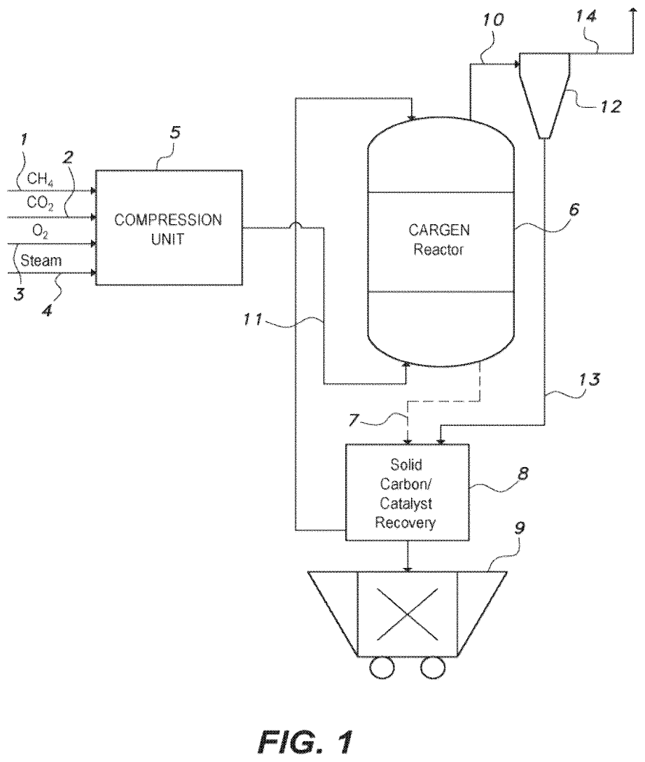

FIG. 1 shows a conceptual process flow diagram to depict the operation of the carbon generator (CARGEN) reactor or the first reactor in the two-reactor system of the present teachings. Compression unit 5 receives methane 1, carbon dioxide 2, oxygen 3, and steam 4 inputs. Compression unit 5 provides output 6 of compressed feed gas mix to the CARGEN reactor 7. The CARGEN reactor 7 outputs the unreacted gases 10, which goes to a cyclone or electrostatic precipitator 12, which produces unreacted methane 1, carbon dioxide 2, steam 14, and recovered solid carbon 13. A solid carbon/catalyst recovery unit 8 receives inputs of the spent catalyst and solid carbon 11 from the CARGEN reactor 7 and the recovered solid carbon 15 from the cyclone or electrostatic precipitator 12. The catalyst recovered is regenerated and fed back to the CARGEN reactor 6, and the carbon is discarded to the discarded carbon and catalyst collector 9.

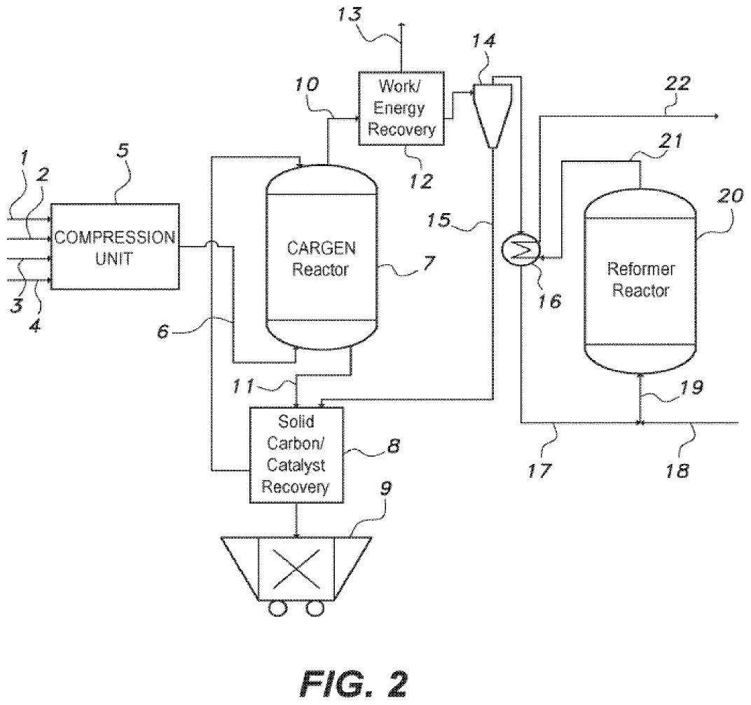

FIG. 2 is a non-limiting example of the two-reactor system according to the present subject matter. FIG. 2 shows a compression unit 5 receiving inputs of methane 1, carbon dioxide 2, oxygen 3, and steam 4. Compression unit 5 provides output 6 of compressed feed gas mix to the CARGEN reactor 7. According to an embodiment, a work/energy recovery unit 12 can be provided. The CARGEN reactor 7 can provide an output 10 of unreacted gases from the CARGEN reactor at a high pressure to the work/energy recovery unit 12.

The work/energy recovery unit 12 can then output extracted work/energy 13 and provide feed to the cyclone/electrostatic precipitator 14. The cyclone/electrostatic precipitator 14 provides outputs of recovered solid carbon 15 to the solid carbon/catalyst recovery unit 8. The solid carbon/catalyst recovery unit 8 regenerates the catalyst (removes carbon from the catalyst) and provides the catalyst back to the CARGEN reactor 7. Any carbon and/or catalyst to be discarded is directed to the discarded carbon/catalyst collector 9. The cyclone/electrostatic precipitator 14 also outputs unreacted methane, carbon dioxide, and/or steam to a heat exchanger unit 16. From the heat exchanger unit 16, high temperature and low-pressure gases 17 are directed to the reformer reactor or second reactor 20. An additional feed of methane, oxygen, and steam 18 combine with the high temperature and low-pressure gases from the heat exchanger unit 17 to serve as feed gases 19 to the reformer reactor 20. The reformer reactor 20 then outputs high temperature syngas 21 to the heat exchanger unit 16. The heat exchanger unit 16 outputs low temperature syngas 22.

The present carbon catalyst separation process, as shown by the solid carbon/catalyst recovery unit 8, can improve the quality of the carbon produced during the carbon generation process. The present process also provides a pathway for recycling of unused catalysts (e.g., unused CARGEN catalyst) present in the bulk phase for subsequent cycles of operation. Since the present carbon catalyst separation process is an additional feature that can be utilized during carbon generation/production, the present process shares equal commercialization possibilities as that of the carbon generation/production process, such as the CARGEN process. For example, the present carbon catalyst process can improve the overall economic efficiency of the carbon generation/production process (e.g., CARGEN process) by reducing the cost of a catalyst material which would be recycled back after separation. According to an embodiment, a method of carbon/catalyst separation is integral to, for example, the CARGEN process, and can enable significant catalyst cost reduction while improving the quality of the produced carbon material.

According to an embodiment of the present disclosure, a method for separating carbon and catalyst bulk mixture in association with a CARGEN process is provided. The method enables the recovery of supported/unsupported catalysts from the carbon/catalyst mixture produced from the CARGEN process. In this regard, the present carbon catalyst separation process can enable the recycling of the catalyst material for subsequent cycles of operation, such as during the CARGEN process operation. For example, the method utilizes mixtures of acids or bases with an organic solvent for the removal of active catalyst particles present in the bulk phase in the powder mixture. The method also optionally utilizes sonication technology to improve recovery. The present disclosure also provides a method for the continuous operation of the CARGEN reactor as well as the catalyst/carbon separation process according to an embodiment.

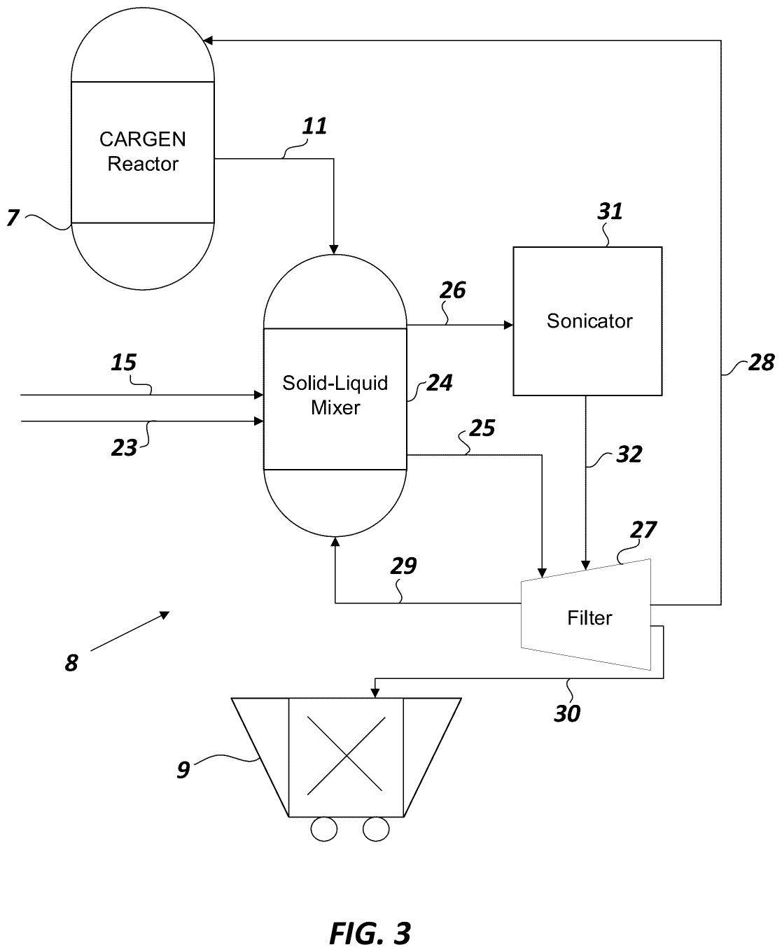

FIG. 3 illustrates the solid carbon/catalyst recovery unit 8. The solid carbon/catalyst recovery unit 8 includes a solid-liquid mixer 24 which receives inputs of spent catalyst and solid carbon 11 from the CARGEN reactor 7, the recovered solid carbon 15 from the cyclone or electrostatic precipitator 12, and a prepared solution 23.

The prepared solution 23 can be a variety of chemical mixtures. The solution 23 may be prepared in any manner known to a person having ordinary skill in the art. This may include mixing the ingredients in a vessel. The following paragraphs identify some non-limiting exemplary solution 23 mixtures.

A first example of a solution 23 includes a mixture of dilute acids including hydrochloric acid and nitric acid. The hydrochloric acid and nitric acid may be diluted through the addition of water into the solution 23. In this example, the hydrochloric acid and nitric acid do not exceed 5% of the volume of the overall solution 23.

A second example of a solution 23 includes a mixture of sulfuric acid and water. By mixing the sulfuric acid in water, the sulfuric acid becomes diluted. The sulfuric acid may be limited to 5% of the volume of the overall solution 23.

A third example of a solution 23 includes a mixture of dilute acids, including hydrochloric acid and nitric acid, and methanol. This mixture may also be diluted through the addition of water. The solution's acidic strength, or hydrochloric and nitric acid addition, may be limited to 5% by volume. Finally, the amount of methanol does not exceed 50% of the volume of the overall solution 23.

A fourth example of solution 23 includes a mixture of dilute acids, including sulfuric acid, and methanol. This mixture may also be diluted through the addition of water. The solution's acidic strength, or the addition of sulfuric acid, may be limited to 5% by volume. Finally, the amount of methanol does not exceed 50% of the volume of the overall solution 23.

A fifth example of solution 23 includes a basic sodium hydroxide and water mixture. The sodium hydroxide may create a strong basic solution exhibiting a Molar concentration of up to 6.

A sixth example of solution 23 includes a basic mixture of sodium hydroxide, methanol, and water. The sodium hydroxide may create a strongly basic solution exhibiting a Molar concentration of up to 6. The amount of methanol does not exceed 50% of the volume of the overall solution 23.

Returning to FIG. 3, the solid-liquid mixer 24 receives inputs of spent catalyst and solid carbon 11 from the CARGEN reactor 7, the recovered solid carbon 15 from the cyclone or electrostatic precipitator 12, and the prepared solution 23. As described further below, the amounts of each input are limited to optimally facilitate a reaction. The solid-liquid mixer 24 may be any type of mixer known to a person having ordinary skill in the art, including, but not limited to, tank mixers or drum mixers. The mixing conditions of the solid-liquid mixer 24 are carefully controlled such that the temperature of the mixer 24 and the time spent in the reactor are predetermined by the methods described below.

In an embodiment, the stream from the solid-liquid mixer 25 is directed into a filter 27. In another embodiment, the stream from the solid-liquid mixer 26 is directed into a sonicator 31 prior to filtration. The sonicator 31 further mixes the stream by applying ultrasonic waves to the mixture. In an embodiment, the sonicator 31 may be operated at variable frequencies that are optimized for the disengagement of carbon. This may allow for more efficient interaction of the materials within the solution 23 to remove the catalyst material. The sonicator 31 may be any sonicator 31 known to a person having ordinary skill in the art, including, but not limited to, probe sonicators or bath sonicators.

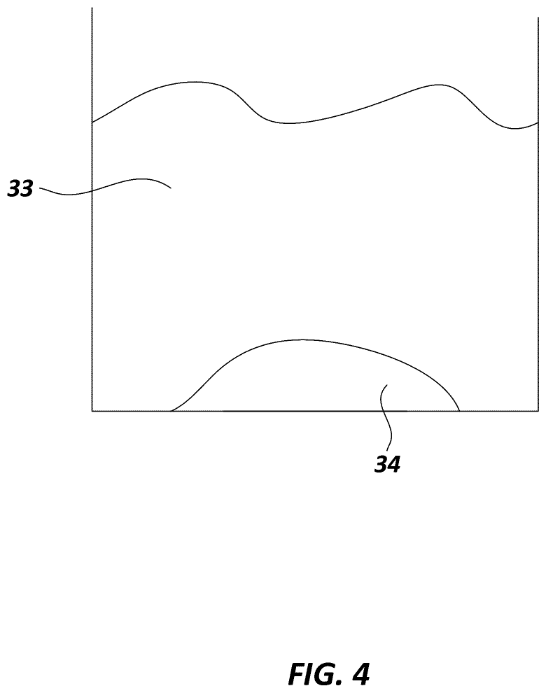

The overall mixing process of the solid-liquid mixer 24 and, in an embodiment, the sonicator 31 produces a stream including a supernatant liquid 33 and a solid precipitate 34. This output stream is illustrated in FIG. 4. The solid precipitate 34 is primarily carbon. A suspended supernatant liquid 33 primarily includes the catalyst and the compounds from the originally prepared solution 23. The supernatant liquid 33 may be further processed to extract the catalyst further.

Once the mixing process is completed, stream 25 or 32, which includes the supernatant liquid 33 and solid precipitate 34, enters filter 27. Filter 27 may be any filter 27 known to a person having ordinary skill in the art, including, but not limited to, membrane filtration, cyclone filtration, or electrostatic precipitators. The filtering conditions of filter 27 are carefully controlled such that the temperature of mixer 24 and the time spent in the reactor are predetermined by methods described below.

The catalyst recovered is regenerated and fed back to the CARGEN reactor 6, and the carbon is discarded to the discarded carbon and catalyst collector 9.

Any carbon and/or catalyst to be discarded is directed to the discarded carbon/catalyst collector 9. From filter 27, the precipitate 34 streams 30 is either directed to the discarded carbon/catalyst collector 9 or be directed the solid-liquid mixer 24 in stream 29. The precipitate 34 may be passed through the sonicator 31 and solid-liquid mixer 24 until no further catalyst recovery is possible. The supernatant liquid 33 stream is directed to either the CARGEN reactor 7 in stream 28 or the solid-liquid mixer 24 in a stream 29.

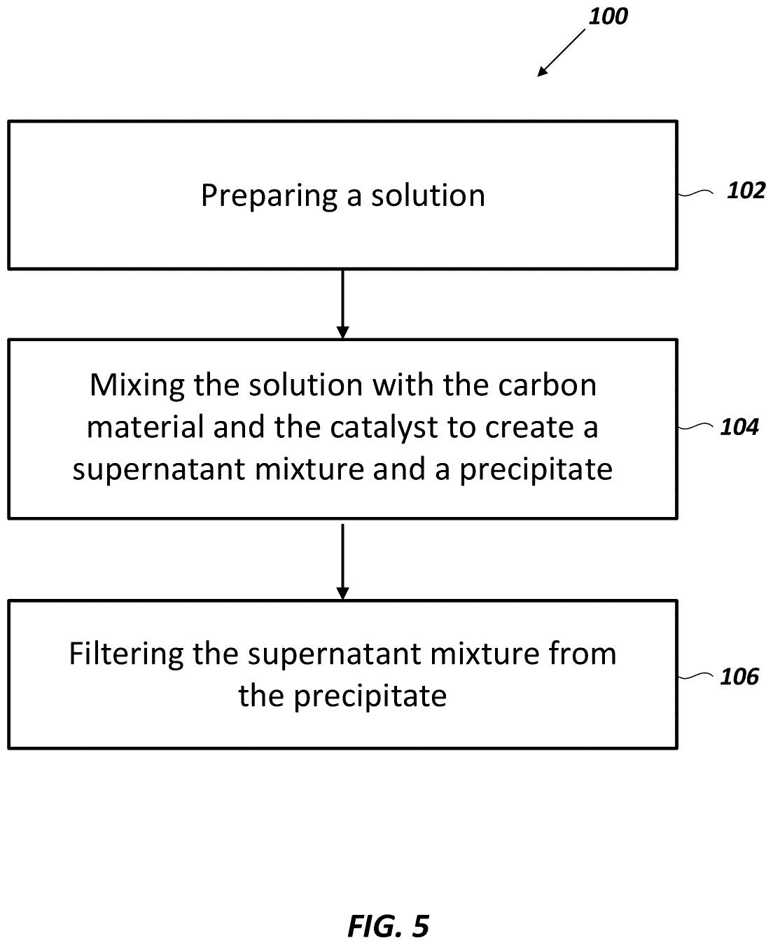

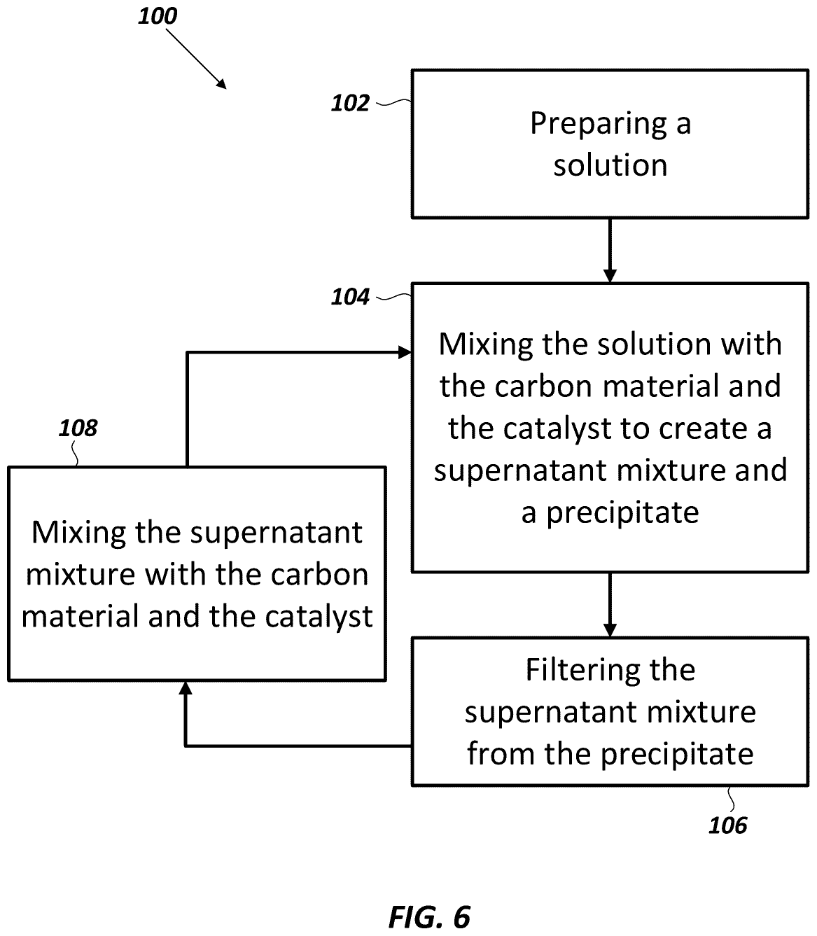

Thus, a method 100 for separating solid carbon and catalyst is generally provided in FIG. 5. In a first step 102, the solution 23 is prepared. In a second mixing step 104, the solution 23 is mixed with inputs of spent catalyst and solid carbon 11 from the CARGEN reactor 7 and the recovered solid carbon 15 from the cyclone or electrostatic precipitator 12 to create a supernatant mixture 33 and a precipitate 34. In a third filtering step 104, the supernatant mixture 33 is filtered from the precipitate 34. Alternatively, in some embodiments, such as that shown in FIG. 6, the method 100 further includes step 108 of recycling the supernatant mixture 33 into mixing step 104.

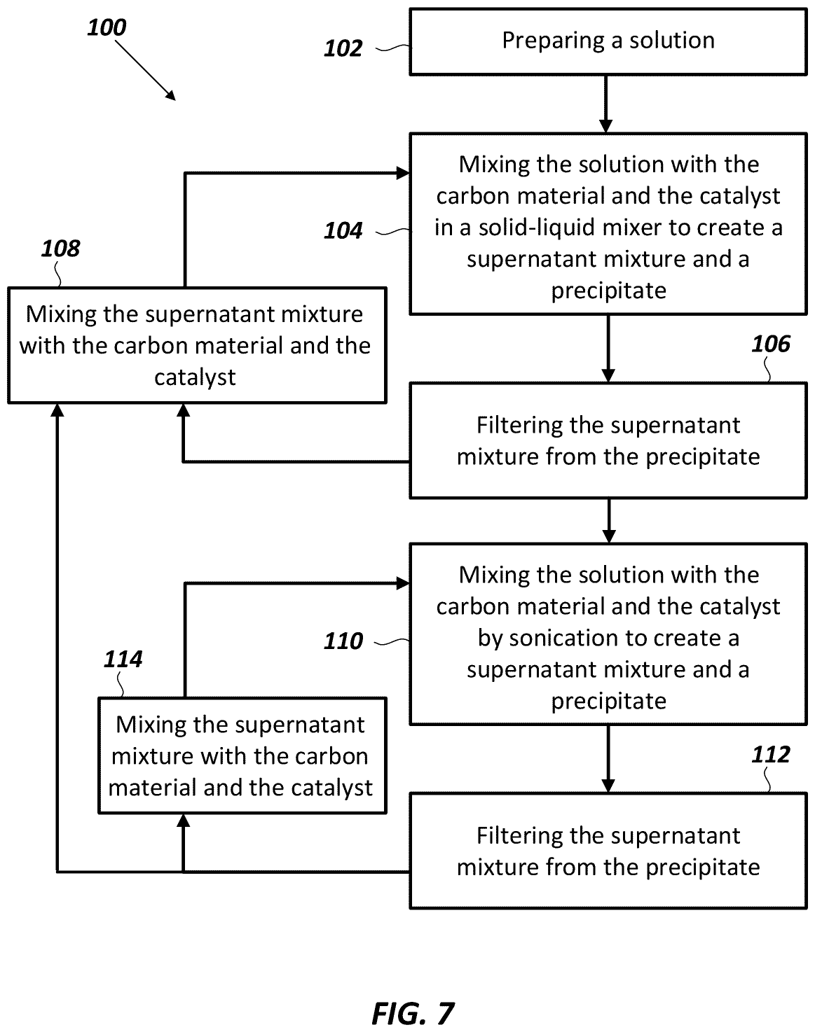

FIG. 7 illustrates method 100, including sonication. In the first step 102, solution 23 is prepared. In a second mixing step 104, the solution 23 is mixed with inputs of spent catalyst and solid carbon 11 from the CARGEN reactor 7 and the recovered solid carbon 15 from the cyclone or electrostatic precipitator 12 to create a supernatant mixture 33 and a precipitate 34. This mixing step 104 occurs in the solid-liquid mixer 24. In a third filtering step 104, the supernatant mixture 33 is filtered from the precipitate 34. From the third filtering step 106, the supernatant mixture 33 may be recycled into the solid-liquid mixing step 104 or may be instead redirected to a sonication mixing step 110 to mix with the solution, the carbon material, and the catalyst by ultrasonic waves to create more supernatant mixture 33 and further create a precipitate 34. In the fifth filtering step 104, the supernatant mixture 33 is again filtered from the precipitate 34. Finally, this supernatant mixture 33 may again be recycled by mixing the supernatant mixture 33 with the carbon material and the catalyst 108, 114. It then can be directed to the solid-liquid mixer 24 or the sonicator 31.

A further description of the present carbon catalyst separation process is provided below according to an embodiment. It should be appreciated that the present carbon catalyst separation process is not limited to the following process details and can include one or more of the following process details and carried out in any suitable manner and order: (1) A preparation step of a mixture of dilute acids comprising hydrochloric acid and nitric acid not exceeding 5% acid strength by volume in water: (2) a preparation step of a mixture of dilute sulfuric acid not exceeding 5% acid strength by volume in water: (3) a preparation step of a mixture of dilute acids comprising hydrochloric acid and nitric acid with organic solvent methanol (MeOH) where the acid strength does not exceed 5% of the overall volume and the methanol does not exceed 50% of the overall volume: (4) a preparation step of a mixture of dilute acids comprising sulfuric acid with organic solvent methanol (MeOH) where the acid strength does not exceed 5% of the overall volume and the methanol does not exceed 50% of the overall volume: (5) a preparation step of a strong basic solution of sodium hydroxide (NaOH) with a strength up to 6 Molar: (6) a preparation of a strong basic solution of sodium hydroxide (NaOH) with organic solvent methanol where the base strength does not exceed 6 Molar and the methanol does not exceed 50% of the overall volume: (7) a solid-liquid mixing step in which, for example, a mixture sample of 100 mg of carbon/catalyst is allowed to mix with 10 mL of 5% volume hydrochloric and nitric acid solution at 50° C. for 3 hours: (8) a filtration step to separate the supernatant liquid from the solid carbon with the supernatant liquid may be further processed to recover the valuable catalyst material: (9) a solid-liquid mixing step in which the mixture sample of 100 mg of carbon/catalyst is allowed to mix with 10 mL of 5% volume sulfuric acid solution at 50° C. for 3 hours: (10) a filtration step to separate the supernatant liquid from the solid carbon where the supernatant liquid may be further processed to recover the valuable catalyst material: (11) a solid-liquid mixing step in which the mixture sample of 100 mg of carbon/catalyst is allowed to mix with 5 mL of 5% volume hydrochloric & nitric acid solution and 5 mL of MeOH solution at 50° C. for 3 hours: (12) a filtration step to separate the supernatant liquid from the solid carbon where the supernatant liquid may be further processed to recover the valuable catalyst material: (13) a solid-liquid mixing step in which the mixture sample of 100 mg of carbon/catalyst is allowed to mix with 5 mL of 5% volume sulfuric acid and 5 mL of MeOH solution at 50° C. for 3 hours: (14) a filtration step to separate the supernatant liquid from the solid carbon where the supernatant liquid may be further processed to recover the valuable catalyst material; (15) a solid-liquid mixing step in which the mixture sample of 100 mg of carbon/catalyst is allowed to mix with 5 mL of NaOH solution at 50° C. for 10 minutes: (16) a filtration step to separate the supernatant liquid from the solid carbon where the supernatant liquid may be further processed to recover the valuable catalyst material: (17) a solid-liquid mixing step in which the mixture sample of 100 mg of carbon/catalyst is allowed to mix with 5 mL of NaOH solution and 5 mL of MeOH solution at 50° C. for 10 minutes: (18) a filtration step to separate the supernatant liquid from the solid carbon where the supernatant liquid may be further processed to recover the valuable catalyst material: (19) a solid-liquid mixing and sonication step in which the mixture sample of 100 mg of carbon/catalyst is allowed to mix with 10 mL of 5% volume hydrochloric and nitric acid solution at 50° C. for 1 hour: (20) a filtration step to separate the supernatant liquid from the solid carbon where the supernatant liquid may be further processed to recover the valuable catalyst material: (21) a solid-liquid mixing and sonication step in which the mixture sample of 100 mg of carbon/catalyst is allowed to mix with 10 mL of 5% volume sulfuric acid solution at 50° C. for 1 hour: (22) a filtration step to separate the supernatant liquid from the solid carbon where the supernatant liquid may be further processed to recover the valuable catalyst material: (23) a solid-liquid mixing and sonication step in which the mixture sample of 100 mg of carbon/catalyst is allowed to mix with 5 mL of 5% volume hydrochloric & nitric acid solution and 5 mL of MeOH solution at 50° C. for 1 hour: (24) a filtration step to separate the supernatant liquid from the solid carbon where the supernatant liquid may be further processed to recover the valuable catalyst material: (25) a solid-liquid mixing and sonication step in which the mixture sample of 100 mg of carbon/catalyst is allowed to mix with 5 mL of 5% volume sulfuric acid and 5 mL of MeOH solution at 50° C. for 1 hour: (26) a filtration step to separate the supernatant liquid from the solid carbon where the supernatant liquid may be further processed to recover the valuable catalyst material: (27) a solid-liquid mixing and sonication step in which the mixture sample of 100 mg of carbon/catalyst is allowed to mix with 5 mL of NaOH solution at 50° C. for 10 minutes: (28) a filtration step to separate the supernatant liquid from the solid carbon where the supernatant liquid may be further processed to recover the valuable catalyst material: (29) a solid-liquid mixing and sonication step in which the mixture sample of 100 mg of carbon/catalyst is allowed to mix with 5 mL of NaOH solution and 5 mL of MeOH solution at 50° C. for 10 minutes; and (30) a filtration step to separate the supernatant liquid from the solid carbon where the supernatant liquid may be further processed to recover the valuable catalyst material.

It should be understood that the process details mentioned above are not required to be followed in exact order, when combined in a suitable manner where applicable, and may be interchanged as needed and/or based on the adopted operation, philosophy or guideline.

The present carbon catalyst separation process may be carried out as a continuous mode of operation as may be required during the process according to an embodiment. The continuous mode of operation may facilitate the improvement in the quality of the carbon material. In an embodiment, the continuous mode of operation is integrated into CARGEN technology to continuously recover the catalyst material and process further to mix with make-up catalyst. In an embodiment, a sonication system may be operated at variable frequencies that are optimized for disengagement of the carbon material (e.g., carbon nanotubes) for efficient interaction of a solvent and an acid to remove the catalyst material. In an embodiment, a precipate may be passed through several stages of sonication and solvent separation until no further catalyst recovery is possible.

According to an embodiment of the present carbon catalyst separation process, the recovery of the catalyst material has been tested. For example, Inductive Couple Plasma (“ICP”) tests were conducted to determine the percentage of material recovery associated with the catalyst. For example, it was deduced that a maximum nickel metal recovery of 72% can be achieved using dilute nitric and hydrochloric mix acid solution. A sulfuric acid system also obtained a similar recovery of 72% of nickel. For aluminum support recovery, for example, a 6 Molar NaOH solution with sonication of 1 hour provided a maximum recovery of 25%. It was also found that the sulfuric acid system could recover a maximum of 11% of aluminum along with the above-stated 72% nickel. For both nickel and aluminum recovery, for example, a 5% dilute sulfuric acid system showed desirable recovery of both nickel and aluminum.

A Scanning Electron Microscopy (“SEM”) study was conducted on the filtered carbon samples from all the tests. Imaging was done at 100 KX resolution at 500 nm particle range. This study was done to evaluate if the carbon catalyst separation treatment adversely affected the morphology of the carbon material (e.g., carbon nanotubes (“CNT”)). It was observed that the NaOH-treated samples significantly damaged the carbon material (e.g., CNT material). On the other hand, the sulfuric acid-treated carbon samples were observed to be highly intact, while the nitric acid-treated carbon sample showed some damage to the carbon material structure (e.g., CNT structure). From an imaging point of view, a sulfuric acid-based system provides a desirable recovery without effectively damaging the carbon material structure (e.g., CNT structure).

A Raman analysis can be conducted to determine distortion factor (D/G ratio). This analysis enables deduction of the carbon catalyst separation treatment that does not affect carbon material structure (e.g., CNT structure).

The methods described above may be performed in any order and the methods described above may include more, fewer, or other steps.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of separating a carbon material from a catalyst for a carbon generation process comprising:
preparing a solution;
mixing the solution with the carbon material and the catalyst in a solid-liquid mixer to create a supernatant mixture and a precipitate; and
filtering the supernatant mixture from the precipitate.

2. The method of claim 1, wherein the carbon generation process includes a CARGEN process.

3. The method of claim 1, wherein the catalyst includes a metal supported on a catalyst support material.

4. The method of claim 1, wherein the solution includes a hydrochloric acid and a nitric acid.

5. The method of claim 1, wherein the solution includes a sulfuric acid and a nitric acid.

6. The method of claim 1, wherein the solution includes a hydrochloric acid, a nitric acid, and a methanol.

7. The method of claim 6, wherein the methanol has a maximum volume concentration of 50%.

8. The method of claim 1, wherein the solution includes a sulfuric acid and a methanol.

9. The method of claim 8, wherein the methanol has a maximum volume concentration of 50%.

10. The method of claim 1, wherein the solution includes a sodium hydroxide.

11. The method of claim 1, wherein the solution includes a sodium hydroxide and a methanol.

12. The method of claim 11, wherein the methanol has a maximum volume concentration of 50%.

13. The method of claim 1, wherein the solution has a volume concentration of 5% or less.

14. The method of claim 1, wherein the solution has a molar concentration of 6 or less.

15. The method of claim 1, wherein the solution is mixed with the carbon material and the catalyst at up to 50° C.

16. The method of claim 15, wherein the solution is mixed with the carbon material and the catalyst for up to three hours.

17. The method of claim 15, wherein the solution is mixed with the carbon material and the catalyst for up to ten minutes.

18. The method of claim 15, wherein the solution is mixed with the carbon material and the catalyst for up to one hour.

19. The method of claim 1, further comprising mixing the solution with the carbon material and the catalyst by sonication to create the supernatant mixture and the precipitate.

20. The method of claim 1, further comprising:
mixing the supernatant mixture with the carbon material and the catalyst in the solid-liquid mixer to create the precipitate; and
filtering the supernatant mixture from the precipitate.

21. The method of claim 20, further comprising mixing the supernatant mixture with the carbon material and the catalyst by sonication to create the precipitate.

22. The method of claim 1, wherein the method is operated in a continuous mode to facilitate improvement in a quality of the carbon material.

23. The method of claim 22, further comprising:
recovering the catalyst continuously to provide a make-up catalyst; and
mixing the catalyst with the make-up catalyst.

24. The method of claim 19, wherein a sonicator configured to mix the solution with the carbon material and the catalyst by sonication is operated at variable frequencies that are optimized for disengagement of the carbon material for efficient interaction of a solvent and an acid to remove the catalyst material.

25. The method of claim 1, further comprising:
mixing the precipitate with the carbon material and the catalyst to create the supernatant mixture and a filtered precipitate; and
filtering the supernatant mixture from the filtered precipitate.
